(19) United States
(12) Patent Application Publication
(10) Pub. No.: US 2008/0009991 A1
(43) Pub. Date: Jan. 10, 2008

(54) Automated vehicular device control apparatus

(75) Inventor: Kazuo Nakamura, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/822,290

(22) Filed: Jul. 3, 2007

(30) Foreign Application Priority Data
Jul. 7, 2006 (JP) 2006-188057

(51) Int. Cl. G05B 15/00; G06F 19/00

(52) U.S. Cl. 701/36

(57) ABSTRACT

An automated vehicular device control apparatus includes a position detector, instruction input switches for executing an automated operation, and a control unit. The control unit uses the position detector for detecting the position of the self-vehicle when the control unit recognizes an input of an instruction for executing the automated operation on the input unit. Then, the position of the self-vehicle is, by the control unit, used for acquiring position characteristic information that corresponds to the position of the self-vehicle, and is used for acquiring the vehicular device operation pattern information that is in correspondence with the position characteristic information.

### CROSS REFERENCE TO RELATED APPLICATION

This application is based on and claims the benefit of priority of Japanese Patent Application No. 2006-188057 filed on Jul. 7, 2006, the disclosure of which is incorporated herein by reference.

### FIELD OF THE INVENTION

The present invention generally relates to a vehicular device control apparatus having automated operation feature for use in a vehicle.

### BACKGROUND INFORMATION

In recent years, various devices and equipment are provided in a vehicle such as an audio system, an air-conditioner, a cruise control and the like. As the number of devices and equipment increases, so is the number of the switches for controlling those devices. The problem is that arranging all those switches in positions that are convenient for the user operation, or the driver's operation, is difficult.

As a measure for coping with the difficulty, a convenient arrangement of frequently used switches on a steering wheel is disclosed in Japanese patent document JP-A-H06-247228. Even in this case, the user is not free from identifying a specific switch among plural switches when he/she intends to control a specific device among plural devices.

Further, use of a microphone, a voice recognition apparatus and a voice command system for operating a vehicle device of interest is disclosed in Japanese patent document JP-A-H09-34488. The disclosure is intended to free the user from troubles of switch operations.

However, even in the system described above in the second disclosure, the user has to voice the command that specifically executes an intended operation, thereby making it troublesome for the user to voice respective operation commands that corresponds to the intended result of operations.

### SUMMARY OF THE INVENTION

In view of the above and other problems, the present invention provides an automated vehicular device control apparatus that performs an automated operation of vehicular devices according to a position characteristic of a vehicle such as a parking position, a traveling position or the like.

The vehicular device control apparatus for controlling a self-vehicle includes a vehicle position detection unit that detects a position of a self-vehicle, an input unit that inputs an instruction for an execution of an automated operation, and a control unit that operates a vehicular device in the self-vehicle based on vehicular device operation pattern information. When the control unit recognizes an input of the instruction for the execution of the automated operation on the input unit, the control unit uses the vehicle position detection unit for detecting the position of the self-vehicle. Then, the position of the self-vehicle is used for acquiring position characteristic information that is in association with the position of the self-vehicle by the control unit, and is used for acquiring the vehicular device operation pattern information that is in correspondence with the position characteristic information. In this manner, when the user intends to control the vehicular device such as a trip meter for resetting its reading, the vehicular device control apparatus automatically recognizes the user needs for resetting the trip meter after re-fueling the vehicle at a gas station, and automatically performs a resetting operation when the vehicle is re-fueled at the gas station, thereby saving the user from controlling a specific switch that instructs an intended device to perform a desired operation.

### BRIEF DESCRIPTION OF THE DRAWINGS

Other objects, features and advantages of the present invention will become more apparent from the following detailed description made with reference to the accompanying drawings, in which:

FIG. 1 shows a block diagram of an automated vehicular device control apparatus in a first embodiment of the present disclosure;

FIG. 2 shows a diagram of a content of information used in the apparatus;

FIG. 3 shows a flowchart of a control performed by the automated vehicular device control apparatus in the first embodiment of the present disclosure;

FIG. 4 shows a flowchart of a control performed by the automated vehicular device control apparatus in a second embodiment of the present disclosure;

FIG. 5 shows a flowchart of a control performed by the automated vehicular device control apparatus in a third embodiment of the present disclosure;

FIG. 6 shows a flowchart of a registration control process; and

FIG. 7 shows a flowchart of a control performed by the automated vehicular device control apparatus in a fourth embodiment of the present disclosure.

### DETAILED DESCRIPTION

Embodiments of the present invention are described with reference to the accompanying drawings.

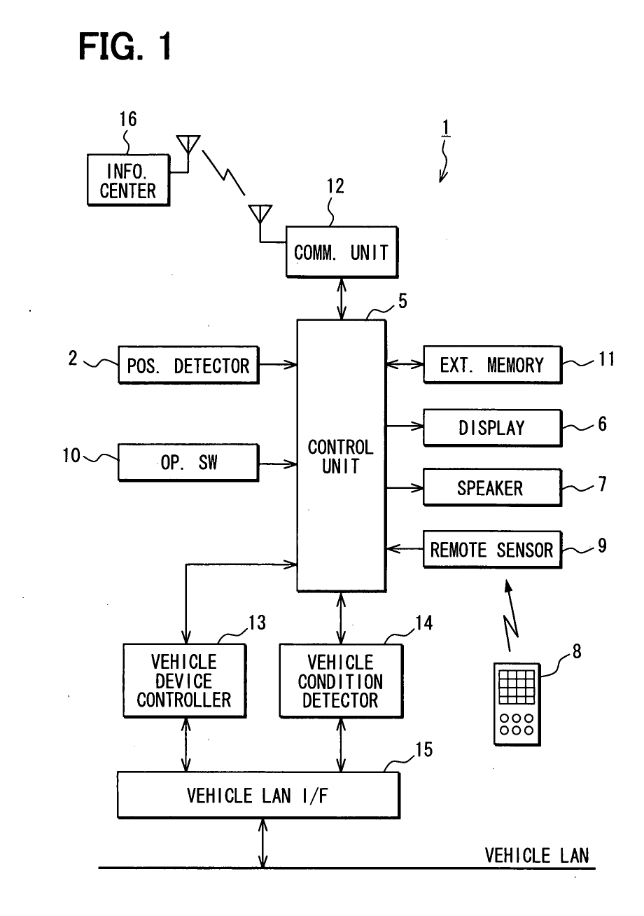

A first embodiment of the present disclosure is described with reference to FIGS. 1 to 3. FIG. 1 shows a block diagram of an automated vehicular device control apparatus 1 disposed in a vehicle in the first embodiment of the present disclosure. As shown in FIG. 1, the automated vehicular device control apparatus 1 includes a position detector 2, a control unit 5 for performing various processes that are required for automated vehicular device control, a display unit 6 for displaying a map and the like, a speaker 7 four outputting sound of notification, a remote sensor 9 for receiving a signal from a remote controller 8, operation switches 10 for inputting various operations that are required for navigation, an external memory 11 for storing information, a communication unit 12, a vehicle device controller 13, a vehicle condition detector 14, and a vehicle LAN interface 15.

The position detector 2 is used for detecting a position of the vehicle, and includes a slant sensor (a pitch angle sensor), a gyroscope, a distance sensor, and a GPS receiver. A GPS signal received by a GPS receiver includes vehicle position information and time information.

The control unit 5 includes a CPU, a ROM, and a RAM. The ROM stores a program that performs display control, vehicle control and the like. This control unit 5 is coupled with the vehicle device controller 13 and the vehicle condition detector 14.

The vehicle device controller 13 controls vehicular devices through the vehicle LAN interface 15 and a vehicle LAN based on a control instruction from control unit 5. The vehicular devices includes an audio equipment with a radio and other units, a fuel lid opener/closer, a door lock apparatus and the like.

In addition, the vehicle condition detector 14 detects a condition of the vehicle through the interface 15 and the vehicle LAN. The vehicle condition detector 14 detects whether the vehicle is traveling, parking or stopping (i.e., a non-traveling condition) or the like.

The operation switches 10 and the remote controller 8 are used to input instructions of various settings. The operation switches 10 include an automated operation switch for inputting an execution instruction of an automated operation. In addition, this automatic operation switch is also used as an information registration switch for registering to the external memory 11 position characteristic information related to a position of the vehicle and vehicle equipment operation pattern information.

The external memory 11 is, for example, a nonvolatile memory, and may have a hard disk with a hard disk drive for driving thereof.

The communication unit 12 has a vehicle data communication module, and can communicate with an information center 16. In addition, the information center 16 holds the position characteristic information for a position (a vehicle position) in a map and the vehicular device operation pattern information that corresponds to the position characteristic information as well as POI information that includes facility information and facility service information as a database. In addition, the information center 16 is capable of delivering road information, traffic information and the like.

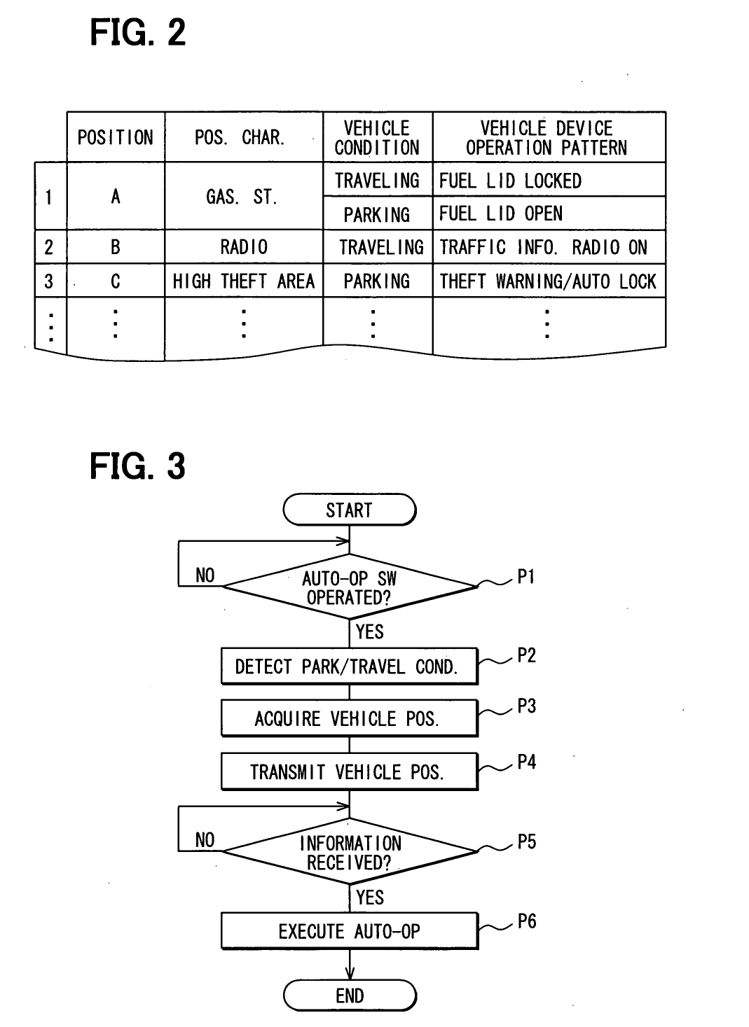

The position characteristic information used in the present embodiment is with regard to facilities and/or conditions being located on the map that relates the vehicle. The content of the database is illustrated in FIG. 2. As shown in FIG. 2, position characteristics include, for example, a gas station, an area of frequent vehicle theft and or frequent theft from a vehicle (i.e., a high theft area hereinafter), a radio traffic information provision area and the like.

Further, a vehicular device operation pattern that corresponds to the position characteristic of ‘gas station’ may be ‘opening a fuel lid,’ ‘resetting a trip meter,’ ‘resetting a cruise computer’ and the like. These patters may be set as a default, or may be set by a user in advance. Furthermore, the vehicular device operation pattern that corresponds to the position characteristic of the ‘high theft area’ may be ‘locking a door,’ ‘warning by voice/sound’ and the like. Furthermore, the vehicular device operation pattern that corresponds to the position characteristic of the ‘radio traffic information provision area’ may be ‘turning on a radio for a specific channel’ or the like. In this case, the vehicular device operation pattern information is accompanied by a condition of a non-traveling (i.e., a parking) and/or a condition of traveling.

The control process of the control unit 5 is described with reference to the flowchart in FIG. 3.

The control process shown in the flowchart is, for example, started at a turn-on of an accessory (ACC) switch. In step P1, the process determines whether the automatic operation switch is operated, and in step P2, the process determines whether the vehicle is parking or traveling when the switch has been operated (P1 :YES). Then, in step P3, the process acquires a position of the vehicle by using the position detector 2. In step P3, the process sends the vehicle position information to the information center 16.

The information center 16 in correspondence sends the position characteristic information corresponding to the vehicle position information and the vehicular device operation pattern in association with the position characteristic to the automated vehicular device control apparatus 1 after extracting them from the database.

In step P5, the process receives the position characteristic information and the vehicular device operation pattern information from the information center 16. Then, the process automatically operates the vehicle device of interest based on the vehicular device operation pattern information.

In this case, the detection result whether the vehicle is parking or traveling and the accompanying condition of the vehicular device operation pattern information for use at the non-traveling time and/or at the traveling time are associated for the execution of an intended vehicular device operation pattern. For example, when the vehicle condition is parking based on the detection result and the position characteristic is ‘gas station,’ the vehicular device operation pattern of ‘opening a fuel lid’ is executed.

Further, when the vehicle condition is traveling based on the detection result and the position characteristic is ‘gas station,’ the vehicular device operation pattern of ‘no opening of a fuel lid’ is executed, or, in other words, no operation is performed.

Furthermore, when the vehicle is in a traveling condition based on the detection result and the position characteristic is ‘radio traffic information provision area,’ the vehicular device operation pattern of ‘turning on a radio for a specific channel’ is executed. Furthermore, when the vehicle is in a parking condition based on the detection result and the position characteristic is ‘radio traffic information provision area,’ the vehicular device operation pattern of ‘turning on a radio for a specific channel’ is not executed.

As shown in the examples described above, when the user provides an input of the instruction for the automated operation from the automated operation switch in the operation switches 1, the position of the vehicle is detected and acquired from the position detector 2, the position characteristic information related to the vehicle position (e.g., a gas station, or a high theft area) is acquired, and the vehicular device operation pattern information in association with the position characteristic (e.g., fuel lid opening, trip meter clear, or a door lock warning/auto door lock) is acquired, and the vehicle device is operated based on the vehicular device operation pattern information acquired from the information center 16. Therefore, when the user wanted the automated operation, the automated operation of the vehicle device that is suitable to the condition of the vehicle position is provided only by operating the automated operation switch. In other words, the number of the switches that are disposed for each of the vehicle devices is reduced, and the trouble of selecting a specific switch for the intended device from among the number of switches is avoided.

In addition, because the automated vehicular device control apparatus 1 in the present embodiment includes the communication unit 12 that is capable of communicating with the information center 16, and the control unit 5 acquires the position characteristic information related to the position of the vehicle and the vehicular device operation pattern information corresponding to the acquired position characteristic from the information center 16 through the communication unit 12, a large volume of memory for storing the position characteristic information and the vehicular device operation pattern information is not required in the apparatus 1, thereby enabling a cost reduction of the apparatus 1 as well as acquisition of the latest information from the information center 16.

In addition, because the vehicular device operation pattern information related to the position characteristic is accompanied by the condition for use at the non-traveling time and/or at the traveling time, and the control unit 5 determines whether the vehicle is parking or traveling for associating the determination result with the vehicular device operation pattern information, the vehicular device operation pattern for use only with the non-traveling time (i.e., a parking time), the pattern for use only with the traveling time, and the pattern for use with both conditions can be automatically selected for use at a specific traveling condition of the vehicle.

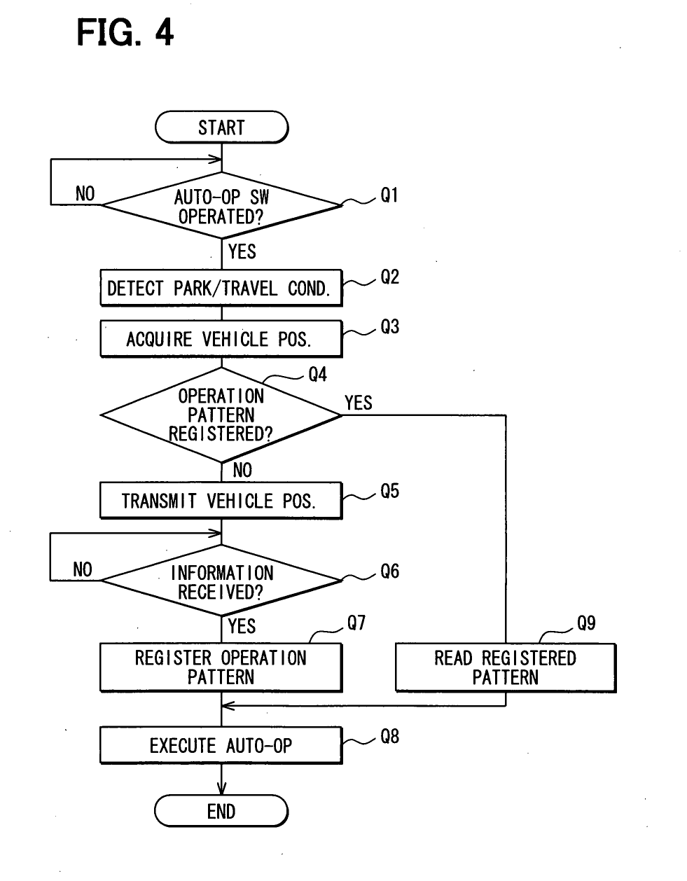

FIG. 4 shows the second embodiment of the present disclosure. In the second embodiment, the external memory 11 is used for storing information after acquiring information from the information center 16. That is, in steps Q1 to Q3, when the automated operation switch is operated, the condition of the vehicle is determined to be either stopping or traveling, and the position of the vehicle is automatically detected by the position detector 2. Then, in step Q4, the external memory 11 is examined that the position characteristic information related to the vehicle position and the vehicular device operation pattern information corresponding to the position characteristic are memorized (registered) or not, and, in step Q5, the vehicle position information is sent to the information center 16 when those information is not registered in the memory 11.

When the position characteristic information and the vehicular device operation pattern information are received from the information center 16 (Q6:YES), the position characteristic information related to the vehicle position and the vehicular device operation pattern information corresponding to the position characteristic acquired from the information center 16 are registered in the external memory 11 in step Q7. Then, in step Q8, the intended vehicle device is automatically operated based on the registered vehicular device operation pattern information in step Q8. When the registered information related to the vehicle position is found in step Q4, the process reads the registered information (the vehicular device operation pattern information) in step Q9, and the intended vehicle device is automatically operated in step Q10.

According to the process in the second embodiment, the communication between the vehicle and the information center 16 for traveling the same place or for parking/stopping at the same place is not required due to the configuration that the position characteristic information and the vehicular device operation pattern information acquired from the information center 16 are stored in the external memory 11 for use in the subsequent travels, thereby enabling a reduction of the control execution time.

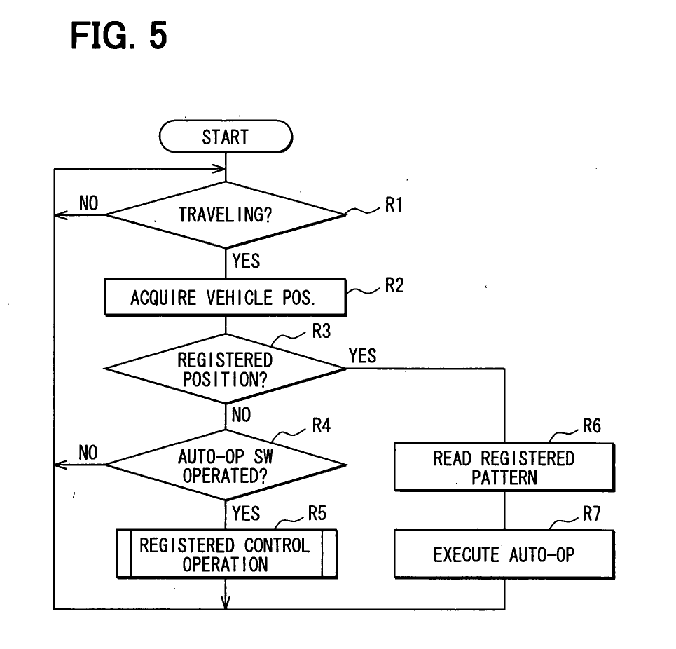

FIG. 5 shows the third embodiment of the present disclosure. In the third embodiment, the automated operation that is automatically started when the vehicle is traveling and the registration control process performed in the traveling condition are the difference from the second embodiment. When the vehicle is traveling (based on the determination in step R1), the vehicle position is detected (in step R2), and the detected vehicle position is compared with the position information in the registered information in the external memory 11 in step R3. When the vehicle position is determined as registered in step R3, the registered information having the detected vehicle position accompanied by the condition for use at the traveling time is retrieved in step R6, and the automated operation is executed based on the retrieved information in step R7.

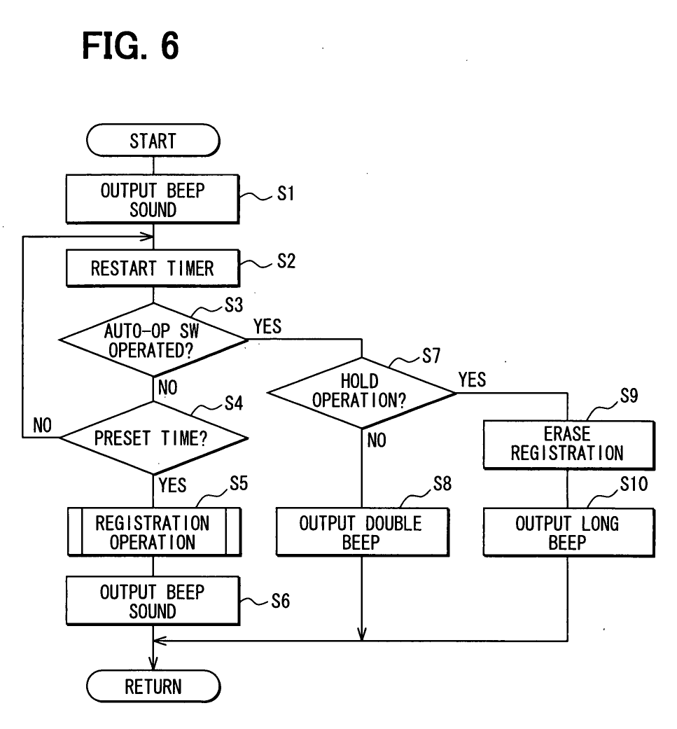

When the registered information is not found in step R3 (R3:NO), and the automated operation switch (in this case, serving as an information registration switch) is operated (R4:YES), a registration control process is performed in step R5. The registration control process is described with reference to FIG. 6. In FIG. 6, after the speaker 7 outputs a single short beep in step S1, the process acquires the position characteristic information related to the vehicle position and the vehicular device operation pattern corresponding to the position characteristic information from the information center 16 for registration in the external memory 11 in step S5 if the automated operation switch. (in this case, serving as a registration cancel switch) is not operated for a predetermined time (S2, S3: NO, and S4:YES). In the registration of the information, the information is accompanied by the condition for use at the traveling time.

The content of step S5 is the same as that of steps Q5 to Q7 in FIG. 4. Then, in step S6, the single short beet is output.

When the automated operation switch is operated in step S3, the registered information is erased by a hold operation of the switch in step S9, and a single long beep is output in step S10. When the switch is operated for a short time in step S7 (S7:NO), no operation is performed and a double short beep is output in step S8.

According to the third embodiment, the position characteristic information for the current vehicle position is always checked for automatically executing the vehicle device operation such as turning on a radio or the like for an improved convenience of the user. In this case, because the registered information of the vehicular device operation pattern accompanied by the condition for use at the traveling time is used for executing the automated operation, the operation such as opening the fuel lid when the vehicle is traveling in front of a gas station is prevented. Further, in the third embodiment, the information acquired from the information center 16 can selectively be registered to the memory 11, and the registered information can selectively be erased from the memory 11, thereby improving the convenience of the user.

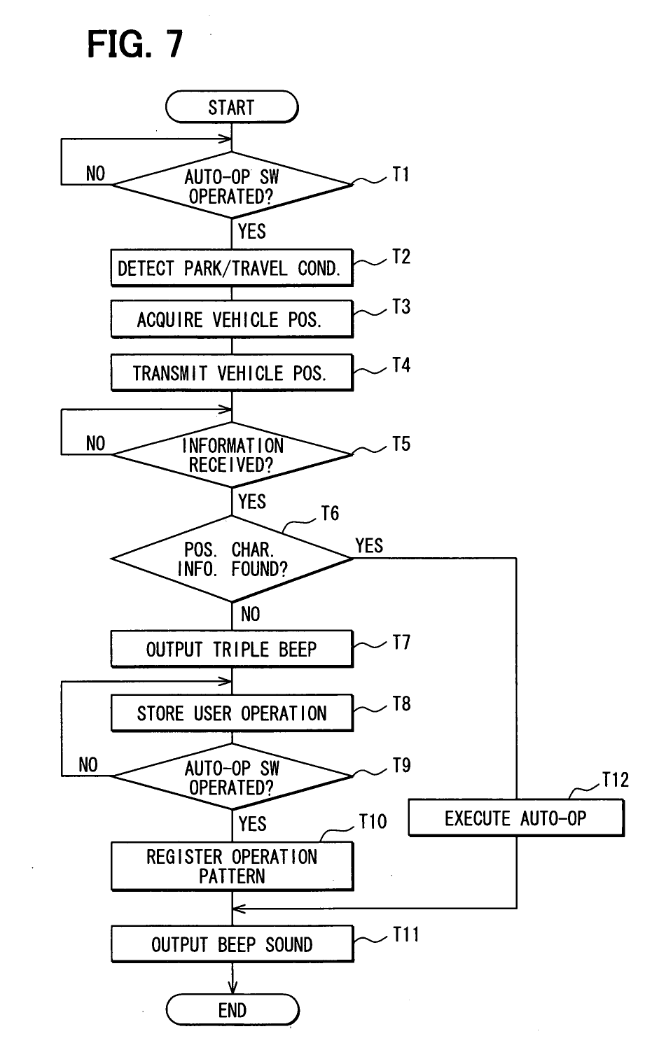

FIG. 7 shows the fourth embodiment of the present disclosure. In the fourth embodiment, the difference from the first embodiment exists in that the operation information of the user is registered as the vehicular device operation pattern information when the position characteristic information and the vehicular device operation pattern information corresponding to the vehicle position are not found in the information center 16. Steps T1 to T5 are equivalent to steps P1 to P5 in FIG. 3. In step T6, the process determines whether the position characteristic information related to the vehicle position is not found in the information acquired from the information center 16 (T6:NO), the process proceeds to step T7 to output a triple short beep for notifying the user that the user operation is registered. Then, in step T8, the content of the user operation such as clearing the trip meter, opening the fuel lid, or the like is temporarily stored until the automated operation switch (in this case, serving as a memorization start switch) is operated (step T9), and the user operation of the vehicle device switches (among the operation switches 10) is used for determining the vehicular device operation pattern and the registration of the determined pattern in the external memory 11 in step T10 when the automated operation switch is operated. Then in step T11, the process outputs a single short beep for notifying an end of the registration.

In this case, when the position characteristic information related to the vehicle position is found in the information acquired from the information center 16 (T6:YES), the process proceeds to step T12 and the automated operation is executed based on the vehicular device operation pattern corresponding to the position characteristic found in step T6.

According to the fourth embodiment, because the user operation of the vehicle device operation switch is used for determining the vehicular device operation pattern information when the position characteristic information related to the vehicle position is not found in the information center 16 and the determined vehicular device operation pattern is stored in the external memory 11 with the vehicle position, an actual user operation of the vehicular device operation pattern information is stored in the information center 16 when the position characteristic information related to the vehicle position, thereby improving the convenience of the user.

Although the present invention has been fully described in connection with the preferred embodiment thereof with reference to the accompanying drawings, it is to be noted that various changes and modifications will become apparent to those skilled in the art.

For example, an information storage that stores the position characteristic information related to the vehicle position and the vehicular device operation pattern information corresponding to the position characteristic may be provided, and the control unit 5 may acquire the position characteristic information related to the vehicle position and the vehicular device operation pattern information corresponding to the position characteristic from the information storage. In this manner, the position characteristic information and the vehicular device operation pattern information can be acquired without having the information center 16, thereby enabling a reduction of the communication unit 12.

Further, the electric beep sound in step S6 in FIG. 6 may be replaced with a voice output such as “Registration complete.” or the like, and the beep in step S8 may be replaced with a voice output such as “Registration cancelled.” or the like as well as replacing the beep in step S10 with “Registration erased.” or the like. Furthermore, other voice output may be additionally provided. Furthermore, the information storage may be adjusted to respective countries of export destination by storing different vehicular device operation patterns in association with the position characteristic and the country name of the export destination when the operation specification of the vehicle device varies depending on the countries. For example, two different specifications of the wireless key for locking the door, that is, a first specification for North America that locks the door upon pressing a button twice and a second specification for Japanese that locks the door upon pressing a button only once, or similar variations may be handled by a single ECU.

Furthermore, the vehicle condition detector 14 may be directly used for detecting vehicle speed pulses without connecting to the vehicle LAN.

Such changes and modifications are to be understood as being within the scope of the present invention as defined by the appended claims.

What is claimed is:

1. A vehicular device control apparatus for controlling a self-vehicle comprising:
a vehicle position detection unit that detects a position of the self-vehicle;
an input unit that inputs an instruction for an execution of an automated operation; and
a control unit that operates a vehicular device in the self-vehicle based on vehicular device operation pattern information,
wherein, when the control unit recognizes an input of the instruction for the execution of the automated operation to the input unit, the control unit uses the vehicle position detection unit for detecting the position of the self-vehicle, and
the position of the self-vehicle is used for acquiring position characteristic information that is in association with the position of the self-vehicle by the control unit, and is used for acquiring the vehicular device operation pattern information that is in correspondence with the position characteristic information.

2. The vehicular device control apparatus as in claim 1 further comprising:
a communication unit that is capable of communicating with an external information center,
wherein the control unit acquires the vehicular device operation pattern information that is in correspondence with the position characteristic information that is in association with the position of the self-vehicle through the communication unit from the external information center.

3. The vehicular device control apparatus as in claim 2 further comprising:
an information storage that stores information,
wherein the control unit stores the position of the self-vehicle, the position characteristic information and the vehicular device operation pattern information in the information storage for use in subsequent operations of the vehicular device.

4. The vehicular device control apparatus as in claim 3,
wherein the control unit controls the vehicle position detection unit for detecting the position of the self-vehicle while the self-vehicle is running, and
when the position characteristic information in association with the position of the self-vehicle agrees with the position characteristic information stored in the information storage, the control unit operates the vehicular device based on the vehicular device operation pattern information that corresponds to the position characteristic information.

5. The vehicular device control apparatus as in claim 1,
wherein the vehicular device operation pattern information corresponding to the position characteristic information is accompanied by a non-traveling time condition that is used in a non-traveling time of the self-vehicle and/or a traveling time condition that is used in a traveling time of the self-vehicle, and
the control unit uses the vehicular device operation pattern information that is in association with the condition that corresponds to a determination result whether the self-vehicle is traveling

6. The vehicular device control apparatus as in claim 1 further comprising:
an information memory that stores the position characteristic information in association with the position of the self-vehicle and the vehicular device operation pattern information that corresponds to the position characteristic information,
wherein the control unit acquires the position characteristic and the vehicular device operation pattern information from the information memory.

7. The vehicular device control apparatus as in claim 3 further comprising:
an operation pattern register for storing an operation pattern of the vehicular device; and
a vehicular device operation unit for operating the vehicular device,
wherein the control unit estimates the vehicular device operation pattern information based on a user operation of the vehicular device operation unit when the position characteristic information that corresponds to the position of the self-vehicle is not stored in the information memory, and
the control unit stores estimated vehicular device operation pattern information accompanied by the position of the self-vehicle in the operation pattern register.
